(19) United States
(12) Patent Application Publication
(10) Pub. No.: US 2014/0037900 A1
(43) Pub. Date: Feb. 6, 2014

(54) Active-Energy-Curable Resin Composition, Molding, Microrelief Structure, Water-Repellent Article, Mold, and Method for Producing Microrelief Structure

(71) Applicants: Tsuyoshi Takihara, Hiroshima (JP); Eiko Okamoto, Mitsubishi (JP)

(72) Inventors: Tsuyoshi Takihara, Hiroshima (JP); Eiko Okamoto, Mitsubishi (JP)

(73) Assignee: MITSUBISHI RAYON CO., LTD., Tokyo (JP)

(21) Appl. No.: 14/111,612

(22) PCT Filed: Apr. 12, 2012
(86) PCT No.: PCT/JP2012/059989

§ 371 Date: Oct. 14, 2013

(30) Foreign Application Priority Data
Apr. 15, 2011 (JP) 2011-091118
Mar. 15, 2012 (JP) 2012-058587

(51) Int. Cl. B29C 59/02; B29C 59/16

(52) U.S. Cl. CPC B29C 59/02; B29C 59/16
USPC 428/141; 264/496; 264/293; 425/385; 526/320; 524/558

(57) ABSTRACT

Disclosed is an active energy ray-curable resin composition comprising 3 to 18 parts by mass of an alkyl (meth)acrylate (A) having an alkyl group of 12 or more carbon atoms, and 82 to 97 parts by mass of a multifunctional monomer (B) having 3 or more radical polymerizable functional groups in the molecule wherein the sp value as expressed by the Fedor's estimation method is 20 to 23, per 100 parts by mass of the total content of all monomers, and which gives a cured material having excellent water repellency and scratch resistance; and a molded article, a fine uneven structure body and a water-repellent article prepared by using the active energy ray-curable resin composition; and a method for producing a fine uneven structure body.

### TECHNICAL FIELD

The present invention relates to an active energy ray-curable resin composition which is capable of forming a fine uneven structure body having excellent water-repellent effects such as a water drop falling down property and high scratch resistance together; and a molded article, a fine uneven structure body, a water-repellent article and a mold prepared by using the active energy ray-curable resin composition, and a method for producing a fine uneven structure body.

### BACKGROUND ART

It is known that a fine uneven structure body having a fine uneven structure having fine unevenness disposed regularly on its surface exhibits antireflective performance according to a continuous change in refractive index. Intervals between the convex parts or concave parts need to be a size equal to or less than the wavelength of visible light in order for the fine uneven structure to exhibit good antireflective performance. The fine uneven structure body can also exhibit super-water-repellent performance according to the lotus effect.

The following methods are proposed as a method for forming the fine uneven structure: for example, a method for performing injection molding and press molding using a mold having an inversion structure of a fine uneven structure; a method for providing an active energy ray-curable resin composition (hereinafter; referred to also as a “resin composition”) between a mold and a transparent substrate, irradiating the resin composition with an active energy ray to cure the resin composition, transferring the uneven shape of the mold, and thereafter detaching the mold; and a method for transferring the uneven shape of a mold to a resin composition, detaching the mold, and thereafter irradiating the resin composition with an active energy ray to cure the resin composition. Among them, the method for irradiating a resin composition with an active energy ray to cure the resin composition and transferring a fine uneven structure is suitable in light of transferability of the fine uneven structure and the degree of freedom of a surface composition. This method is particularly suitable when a belt-type or roll-type mold capable of being continuously produced is used, and has excellent productivity.

The fine uneven structure body has lower scratch resistance than a molded product such as a hard coat produced using the same resin composition and having a smooth surface, and has a problem with durability in use. When the resin composition used for producing the fine uneven structure body is insufficiently robust, a phenomenon in which projections are disposed close to each other is apt to be generated by mold releasing from a mold and heating.

In order to provide water repellency easily, it is known to blend a water-repellent component such as fluorine-based compounds and silicone-based compounds into a resin composition. It is possible to render surface free energy extremely low by using especially a fluorine-based compound. Further, a fluorine-based compound can also provide oil repellency which cannot be attained by a silicone-based compound.

For example, Patent Document 1 discloses a cured coating excellent in scratch resistance and an antifouling property obtained by using a fluorine-based monomer component having a specific structure. Patent Document 2 discloses a curable composition containing a fluorine-containing polymer. Patent Document 3 discloses a polymer containing both silicon and fluorine and capable of imparting an antifouling property and a slip characteristic.

Patent Document 1, however, describes that transparency is lost when a fluorine-based monomer is added in an amount of 2 parts by mass or more. Further, an organic solvent is necessary for uniformly compatibilizing a fluorine-based monomer and a multifunctional monomer. In this case, there is no significant problem in a process in which a coating solution is applied, then, subjected to a drying step, and polymerized and cured by irradiating with an active energy ray, however, in a process in which a coating solution poured into a mold is polymerized and cured by irradiating with an active energy ray under this state, then, the mold is released, there occurs a problem that a solvent remains in a cured material to render the molded article weak.

Patent Document 2 describes as a problem that a fluorine-containing polymer and a multifunctional monomer are not easily compatibilized, and uses a multifunctional monomer having a specific structure for solving the problem. In both Patent Document 2 and Patent Document 3, compatibilization with a multifunctional monomer is performed using appropriately a solvent. In this case, a problem remains in the polymerizing and curing process via not drying step. Though these oligomers and polymers have a polymerizable reaction group, an ability of increasing cross-link density is limited, and satisfactory hardness cannot be obtained particularly when used as a fine uneven structure body.

Further, the above-described invention aims migration of a fluorine-containing antifouling component to the surface layer in a process of volatilization of a solvent. Therefore, in the molding method in which a coating solution poured into a mold is polymerized and cured by irradiating with an active energy ray under this state, then, the mold is released, it is impossible to obtain comparable level of water repellency and oil repellency.

As described above, there are many proposals on fluorine-containing curable compositions for obtaining an antifouling property, however, these compositions dot not sufficiently satisfy scratch resistance as the resin composition for forming a fine uneven structure. Further, water repellency and oil repellency cannot be imparted to the surface by polymerization and curing in a mold.

In contrast, Patent Document 4, Patent Document 5 and Patent Document 6 disclose post processing treatments by which a fluorine-based compound is applied on the surface of a fine uneven structure body and connected with a silane coupling reaction. By such post processing treatments, a certain level of scratch resistance can be imparted to a fine uneven structure body, however, there are problems such as detaching and slip drop of the surface layer and an increase in the production cost.

In light of the situations described above, the present inventors have proposed an active energy ray-curable resin composition which is capable of forming a fine uneven structure body having high scratch resistance and good water repellency together, and a fine uneven structure body prepared by using the composition and a method for producing the same, and a water-repellent article having a fine uneven structure body (Patent Document 7). According to these inventions, a fine uneven structure body having water repellency can be manufactured by using a water-repellent component having a specific structure compatibilizing with a general-purpose multifunctional monomer, without needing a solvent, not via a complicated step such as a post processing treatment.

The inventions disclosed in Patent Document 7, however, use a special silicone-based compound. Therefore, there is a desire for an active energy ray-curable resin composition which is capable of forming a fine uneven structure body exhibiting good water repellency, using a cheaper and more easily available raw material.

### PRIOR TECHNOLOGICAL DOCUMENT

### Patent Documents

[Patent Document 1] JP-A No. 2009-114248
[Patent Document 2] JP-A No. 2009-167354
[Patent Document 3] JP-A No. 2009-249558
[Patent Document 4] JP-A No. 2007-196383
[Patent Document 5] JP-A No. 2007-144916
[Patent Document 6] JP-A No. 2010-201799
[Patent Document 7] JP-A No. 2010-275525

### SUMMARY OF THE INVENTION

### Problem to be Solved by the Invention

The present invention has been made to solve the above-described problems. That is the object of the present invention is to provide an active energy ray-curable resin composition which gives a cured material showing an antireflection function owing to a fine uneven structure formed on the surface, showing excellent water repellency without using a fluorine-containing compound and a silicone-based compound, and showing high scratch resistance together; and a molded article, a fine uneven structure body, a water-repellent article and a mold prepared by using the active energy ray-curable resin composition; and a method for producing a fine uneven structure body.

### Means for Solving the Problem

The present invention provides an active energy ray-curable resin composition comprising

3 to 18 parts by mass of an alkyl (meth)acrylate (A) having an alkyl group of 12 or more carbon atoms, and

82 to 97 parts by mass of a multifunctional monomer (B) having 3 or more radical polymerizable functional groups in the molecule wherein the sp value as expressed by the Fedor's estimation method is 20 to 23,

per 100 parts by mass of the total content of all monomers.

The present invention also provides a molded article composed of a cured material of the above-described active energy ray-curable resin composition; a fine uneven structure body which is a cured material thereof and having a fine uneven structure on the surface; a water-repellent article having the fine uneven structure body; and a mold having the fine uneven structure body.

The present invention also provides a method for producing a fine uneven structure body comprising a substrate and a cured material having a fine uneven structure on the surface, comprising

providing the above-described active energy ray-curable resin composition between the substrate and a mold having an inversion structure of the fine uneven structure,

curing the activation energy ray-curable resin composition by irradiation of an activation energy ray, and

detaching the mold to form a cured material having the fine uneven structure on the surface.

The present invention also provides a method for producing a fine uneven structure body comprising a substrate and a thermoplastic resin layer having a fine uneven structure on the surface, comprising

providing a thermoplastic resin on the substrate,

pressing the above-described mold onto the thermoplastic resin with heating, and then cooling it, and

detaching the mold to form a cured material having a structure on the surface of the thermoplastic resin layer which corresponds to an inversion structure of the fine uneven structure of the mold.

The present invention also provides a method for producing a fine uneven structure body comprising a substrate and a cured material having a fine uneven structure on the surface, comprising

providing an active energy ray-curable resin composition between the above-described mold and the substrate,

curing the activation energy ray-curable resin composition by irradiation of an activation energy ray, and

detaching the mold to form a cured material having a structure on the surface which corresponds to an inversion structure of the fine uneven structure of the mold.

### Effect of the Invention

The active energy ray-curable resin composition of the present invention effects water repellency by the alkyl (meth)acrylate (A) having an alkyl group of 12 or more carbon atoms and effects appropriate hardness by the multifunctional monomer (B), and a molded body composed of the cured material thereof is excellent in a mechanical property, and suitable for producing a fine uneven structure body having a fine uneven structure on the surface. Since the multifunctional monomer (B) has a specific physical property and a specific structure, the cured material can effect good water repellency while securing the handling ability of the above-described resin composition when the alkyl (meth)acrylate (A) having an alkyl group of 12 or more carbon atoms is used. As a result, the fine uneven structure body of the present invention is excellent in scratch resistance and excellent in a water-repellent effect.

### BRIEF DESCRIPTION OF DRAWINGS

FIG. 1 is a schematic sectional view showing an embodiment of the fine uneven structure body of the present invention.

FIG. 2 is a schematic sectional view showing an example of step for producing a mold used for forming a fine uneven structure.

### MODES FOR CARRYING OUT THE INVENTION

[Alkyl (meth)acrylate (A)]

The alkyl (meth)acrylate (A) used in the present invention is a compound having at least one, preferably one, (meth)acryloyloxy group in the molecule as a radical polymerizable functional group and having an alkyl group of 12 or more carbon atoms.

The alkyl group of 12 or more carbon atoms in the alkyl (meth)acrylate (A) is a portion constituting an ester structure of the (meth)acrylate. Since the number of carbon atoms of this alkyl group is 12 or more, good water repellency can be imparted to a cured material, water drops become difficult to adhere to the surface having a fine uneven structure, and adhered water drops can be allowed to fall down easily. Though the alkyl group may be branched, it is preferable that the alkyl group is linear in light of water repellency. The number of carbon atoms of the alkyl group is 12 or more, preferably 12 to 22, more preferably 12 to 18, particularly preferably 16 to 18. Since the number of carbon atoms is 22 or less, a handling ability is excellent particularly in the case of a linear alkyl group, and for example, a liquid condition is easily formed by heating, and also at room temperature, a wax condition tends to be formed. In the case of a linear alkyl group, the number of carbon atoms thereof is most preferably 16.

It is preferable for the alkyl (meth)acrylate (A) to have one (meth)acryloyloxy group in the molecule as a radical polymerizable functional group. By this, bleed out is apt to be suppressed in a cured material obtained by polymerization thereof together with the multifunctional monomer (B). Since one radical polymerizable functional group is present, the alkyl chain tends to flocculate and it becomes easy to impart water repellency to a cured material.

By combining the alkyl (meth)acrylate (A) with the multifunctional monomer (B), they are compatibilized in heating to provide a transparent and clear curable resin composition, and when cooled down to room temperature, white turbidity is generated and separation occurs in some cases. Further, turbidity and mist occur in a cured material in some cases. However, if the alkyl (meth)acrylate (A) and the multifunctional monomer (B) are well compatibilized, water repellency does not tend to appear. In view of such a point, preferable is a combination in which an inconvenience does not occur in handling of the curable resin composition, and the cured material shows water repellency.

Specific examples of the alkyl (meth)acrylate (A) include lauryl (meth)acrylate, myristyl (meth)acrylate, cetyl (meth)acrylate, stearyl (meth)acrylate and behenyl (meth)acrylate. This may be used alone, or in combination with two or more. The (meth)acrylate denotes a methacrylate or an acrylate. Commercial items thereof include, for example, “BLEMMER LA”, “BLEMMER CA”, “BLEMMER SA”, “BLEMMER VA”, “BLEMMER LMA”, “BLEMMER CMA”, “BLEMMER SMA” and “BLEMMER VMA” manufactured by NOF Corp., and “NK Ester S-1800A” and “NK Ester S-1800M” manufactured by Shin-Nakamura Chemical Co., Ltd. (these are all trade names).

The content of the alkyl (meth)acrylate (A) is 3 to 18 parts by mass, preferably 3 to 12 parts by mass, more preferably 3 to 10 parts by mass, particularly preferably 5 to 8 parts by mass, per 100 parts by mass of the total content of all monomers contained in the composition. When the content is 3 parts by mass or more, good water repellency is obtained. When the content is 18 parts by mass or less, lowering of cross-link density is suppressed and scratch resistance of a cured material can be maintained high.

### [Multifunctional Monomer (B)]

The multifunctional monomer (B) used in the present invention is the main component of a resin composition and plays a role of maintaining a mechanical property of a cured material, especially scratch resistance thereof at a high level, and inducing phase separation in curing. The multifunctional monomer (B) has three or more radical polymerizable functional groups in the molecule. By this, the molecular weight between crosslinking points of a cured material decreases, and the crosslink density is increased, thereby enhancing the elastic modulus and the hardness of a cured material to obtain excellent scratch resistance. This radical polymerizable functional groups is typically a (meth)acryloyl group.

The multifunctional monomer (B) exhibits a specific sp value as expressed by the Fedor's estimation method. The sp value is called by a solubility parameter or a solubility degree parameter, and is a value acting as an index in judging solubility characteristics such as whether a solute is dissolved in a solvent and whether a heterogeneous liquid is mixed. For measuring the sp value, there are in general various methods such as a method of calculating from the heat of vaporization of a liquid and a method of calculation by integrating values based on chemical structures, and known are, for example, the Hildebland sp value, the Hansen sp value, the Kreveren's estimation method and the Fedor's estimation method. These are described in detail in “SP value, base/application and calculation method” published by JOHOKIKO Co., Ltd. In the present invention, the Fedor's estimation method integrating values according to chemical structures is used.

In the present invention, the sp value acts as an index for mutual solubility of monomers. The multifunctional monomer (B) has an sp value as derived by the Fedor's estimation method of 20 to 23, preferably 20.5 to 23, more preferably 20.6 to 22.5. When the sp value is 20 or more, the multifunctional monomer (B) is not excessively compatibilized with the alkyl (meth)acrylate (A) and water repellency of a cured material can be provided. Excessive heating and the like are not necessary for appropriately compatibilizing with the alkyl (meth)acrylate (A) and for obtaining a transparent and clear curable resin composition, leading to an excellent handling ability.

As a further index for solubility, it is preferable that if 95 parts by mass of a multifunctional monomer (B) and 5 parts by mass of stearyl acrylate are mixed and heated to dissolve before being cooled down to 25° C., then, white turbidity and precipitation age generated, and after allowing to stand still overnight, the two components separate.

As the multifunctional monomer (B), use can be made of, for example, tri- or more-functional (meth)acrylates such as epoxy (meth)acrylate, polyester (meth)acrylate and polyether (meth)acrylate. Specific examples thereof include glycerin tri(meth)acrylate, pentaerythritol tri(meth)acrylate, pentaerythritol tetra(meth)acrylate, dipentaerythritol penta(meth)acrylate, dipentaerythritol hexa(meth)acrylate, and ethoxy-modified materials thereof. This may be used alone, or in combination with two or more. Examples of commercial items thereof include ATM-4E in “NK Ester” series manufactured by Shin-Nakamura Chemical Co., Ltd., PEA-12 in “KAYARAD” series manufactured by Nippon Kayaku Co., Ltd., M-305, M-450, M-400 and M-405 in “Aronix” series manufactured by Toagosei Co., Ltd., and “EBECRYL40” manufactured by DAICEL-CYTEC Company, Ltd. (these are all trade names).

The value obtained by dividing the molecular weight of the multifunctional monomer (B) by the number of radical polymerizable functional groups (molecular weight/number of radical polymerizable functional groups) is preferably 200 or less, more preferably 180 or less, particularly preferably 110 to 150. Each of these ranges is effective in view of elastic modulus and hardness of a cured material and scratch resistance of a cured material having a fine uneven structure. In the case of, for example, trimethylolpropane triacrylate, its molecular weight is 296 and the number of radical polymerizable functional groups is 3. Thus, molecular weight/number of radical polymerizable functional groups=98.7.

The content of the multifunctional monomer (B) is 82 to 97 parts by mass, preferably 85 to 97 parts by mass, more preferably 90 to 95 parts by mass per 100 parts by mass of the total content of all monomers contained in the composition. When the content is 82 parts by mass or more, elastic modulus, hardness and scratch resistance of the resultant cured material become to be better. When the content is 97 parts by mass or less, scratch resistance of a cured material is improved, fragility of a cured material can be suppressed, and generation of crack in detaching a mold for forming an uneven structure can be suppressed. In forming a fine uneven structure, a resin of high hardness is necessary since when the shape of projections to be formed on the surface is narrower and higher, it is more difficult to keep the shape. However, even if the height of projections is, for example, over 180 nm, the fine uneven structure can be kept successfully when the content of multifunctional monomer (B) is in the above-described range.

### [Monomer (C)]

The active energy ray-curable resin composition may contain a monomer (C) having at least one radical polymerizable functional group. It is preferable that this monomer (C) is a monomer which is copolymerizable with the alkyl (meth)acrylate (A) and the multifunctional monomer (B) and further improves a handling ability and adhesion with a substrate while maintaining good polymerization reactivity as the whole resin composition.

Though it is preferable that the monomer (C) does not contain a fluorine atom and silicone in the molecule, the monomer (C) may contain in its molecule a fluorine atom and/or silicone in such an amount that water repellency is not deteriorated. It is because compatibilized state of the alkyl (meth)acrylate (A) and the multifunctional monomer (B) is not influenced and scratch resistance and adhesion with a substrate are not so deteriorated under this condition. Regarding the monomer (C), it is preferable that one having an sp value as expressed by the Fedor's estimation method of 20 or more is not used in large amount so that compatibilized state of the alkyl (meth)acrylate (A) and the multifunctional monomer (B) is not influenced and water repellency is not deteriorated.

Specific examples of the monomer (C) include alkyl (meth)acrylates such as methyl (meth)acrylate, ethyl (meth)acrylate, n-butyl (meth)acrylate, butyl (meth)acrylate, t-butyl (meth)acrylate and 2-ethylhexyl (meth)acrylate; benzyl (meth)acrylate; tetrahydrofurfuryl (meth)acrylate; (meth)acrylates having an amino group such as dimethylaminoethyl (meth)acrylate and dimethylaminopropyl (meth)acrylate; (meth)acrylates having a hydroxyl group such as 2-hydroxyethyl (meth)acrylate and hydroxypropyl (meth)acrylate; (meth)acrylamide derivatives such as (meth)acryloylmorpholine and N,N-dimethyl(meth)acrylamide; 2-vinylpyridine; 4-vinylpyridine; N-vinylpyrrolidone; N-vinylformamide; and vinyl acetate. This may be used alone, or in combination with two or more. Among them, (meth)acryloylmorpholine, 2-hydroxyethyl (meth)acrylate, N,N-dimethyl(meth)acrylamide, N-vinylpyrrolidone, N-vinylformamide, methyl (meth)acrylate and ethyl (meth)acrylate are preferable since they are not bulky and capable of promoting polymerization reactivity of a resin composition. Particularly, methyl (meth)acrylate and ethyl (meth)acrylate are preferable when an acrylic film is used as a substrate to be described later.

The content of the monomer (C) is preferably 0 to 15 parts by mass, more preferably 0 to 10 parts by mass, particularly preferably 1 to 10 parts by mass, most preferably 3 to 8 parts by mass, per 100 parts by mass of the total content of all monomers contained in the composition. When the content is 15 parts by mass or less, a resin composition can be cured efficiently, and it is possible to suppress the residual monomer from acting as a plasticizer to exert a reverse influence on elastic modulus and scratch resistance of a cured material. When a fluorine atom and/or silicone is contained, the content is preferably 10 parts by mass or less per 100 parts by mass of the total content of all monomers contained in the composition.

The contents of the alkyl (meth)acrylate (A), the multifunctional monomer (B) and the monomer (C) may be appropriately regulated in the above-described ranges respectively. Particularly, the content of the monomer (C) is preferably determined in a relationship with the content of the alkyl (meth)acrylate (A).

### [Slip Agent (D)]

It is preferable that the active energy ray-curable resin composition contains a slip agent (D). The slip agent (D) is a compound which exists on the surface of a cured resin product and reduces friction on the surface, thereby improving scratch resistance. Commercial items of the slip agent (D) include, for example, “SH3746FLUID” and “FZ-77” manufactured by Dow Corning Toray Co., Ltd., and “KF-355A” and “KE-6011” manufactured by Shin-Etsu Chemical Co., Ltd. (these are all trade names). This may be used alone, or in combination with two or more.

The content of the slip agent (D) is preferably 0.01 to 5 parts by mass, more preferably 0.1 to 2 parts by mass, per 100 parts by mass of the total content of all monomers contained in the composition. When the content is 0.01 part by mass or more, curability of the resin composition is excellent and a mechanical property of a cured material, especially, scratch resistance thereof improves. When the content is 5 parts by mass or less, coloration and a decrease in elastic modulus and scratch resistance due to the slip agent remaining in the cured material can be suppressed,

### [Other Contained Components]

It is preferable that the active energy ray-curable resin composition contains an active energy ray polymerization initiator. This active energy ray polymerization initiator is a compound which is cleaved by irradiation with an active energy ray to generate a radical that initiates a polymerization reaction. The active energy ray means heat rays such as, for example, electron ray, ultraviolet ray, visible ray, plasma and infrared ray. Particularly, the ultraviolet ray is preferably used from the perspectives of apparatus cost and productivity.

Specific examples of the active energy ray polymerization initiator include benzophenone, 4,4-bis(diethylamino)benzophenone, 2,4,6-trimethylbenzophenone, methylorthobenzoyl benzoate, 4-phenylbenzophenone, t-butylanthraquinone, 2-ethylanthraquinone; thioxanthones such as 2,4-diethylthioxanthone and isopropylthioxanthone, 2,4-dichlorothioxanthone; acetophenones such as diethoxyacetophenone, 2-hydroxy-2-methyl-1-phenylpropan-1-one, benzyl dimethyl ketal, 1-hydroxycyclohexyl phenyl ketone and 2-methyl-2-morpholino(4-thiomethylphenyl)propan-1-one, 2-benzyl-2-dimethylamino-1-(4-morpholinophenyl)-butanone; benzoin ethers such as benzoin methyl ether, benzoin ethyl ether, benzoin isopropyl ether and benzoin isobutyl ether; acylphosphine oxides such as 2,4,6-trimethylbenzoyl-diphenylphosphine oxide, bis(2,6-dimethoxybenzoyl)-2,4,4-trimethylpentylphosphine oxide and bis(2,4,6-trimethylbenzoyl)-phenylphosphine oxide; methylbenzoyl formate, 1,7-bisacridinyl heptane, and 9-phenyl acridine. This may be used alone, or in combination with two or more. Particularly, two or more compounds having different absorption wavelengths are preferably used together. If necessary, persulfates such as potassium persulfate and ammonium persulfate; peroxides such as benzoyl peroxide; thermal polymerization initiators such as azo initiators may be used together.

The content of the active energy ray polymerization initiator is preferably 0.01 to 10 parts by mass, more preferably 0.1 to 5 parts by mass, particularly preferably 0.2 to 3 parts by mass, per 100 parts by mass of the total content of all monomers contained in the composition. When the content is 0.01 part by mass or more, curability of the resin composition is excellent and a mechanical property of a cured material, especially, scratch resistance thereof improves. When the content is 10 parts by mass or less, coloration and a decrease in elastic modulus and scratch resistance due to the polymerization initiator remaining in the cured material can be suppressed.

The active energy ray-curable resin composition may contain an active energy ray absorbing agent and/or an antioxidant. The active energy ray absorbing agent is preferably one which can absorb an active energy ray irradiated in curing a resin composition, thereby suppressing deterioration of the resin. The active energy ray absorbing agent includes, for example, benzophenone ultraviolet absorbers, benzotriazole ultraviolet absorbers and benzoate ultraviolet absorbers. Commercial items thereof include, for example, 400 and 479 in “TINUVIN (registered trademark)” series manufactured by Ciba Specialty Chemicals Inc., and 110 in “Viosorb (registered trademark)” series manufactured by Kyodo Chemical Co., Ltd. The antioxidant includes, for example, phenol antioxidants, phosphorus-based antioxidants, sulfur-based antioxidants and hindered amine antioxidants. Commercial items thereof include, for example, “IRGANOX (registered trademark)” series manufactured by Ciba Specialty Chemicals Inc. These active energy ray absorbing agents and antioxidants may be used each alone, or in combination with two or more.

The content of the active energy ray absorbing agent and/or antioxidant is preferably 0.01 to 5 parts by mass, more preferably 0.01 to 1 parts by mass, particularly preferably 0.01 to 0.5 parts by mass, per 100 parts by mass of the total content of all monomers contained in the composition. When the content is 0.01 or more, yellowing of a cured material and an increase in haze thereof can be suppressed, thereby improving weather resistance. When the content is 5 parts by mass or less, curability of a resin composition, scratch resistance of a cured material and adhesion of a cured material with a substrate can be ameliorated.

The active energy ray-curable resin composition may contain, if necessary, additives such as a release agent, a lubricant, a plasticizer, an antistatic agent, a light stabilizer, a fire retardant, a fire-resistant auxiliary agent, a polymerization inhibitor, a filler, a silane coupling agent, a colorant, a reinforcing agent, an inorganic filler and an impact resistance modifier, in such a range that the functions of the multifunctional monomer (A) and the mono(meth)acrylate (B) are not disturbed.

Though the active energy ray-curable resin composition may contain a solvent, it is better that the resin composition contains no solvent. When a solvent is not contained, there is no fear for remaining of a solvent in a cured material, for example, in a process of irradiating a resin composition poured into a mold with an active energy ray to polymerize and cure the resin composition under this condition before releasing the mold. Further, in view of a production step, the facility investment for removal of a solvent is not necessary, thus, also cost performance is advantageous.

### [Physical Property of Resin Composition]

When a fine uneven structure is formed by a mold on the active energy ray-curable resin composition and the resin composition is cured, the viscosity of this resin composition at 25° C. measured by a rotary B-type viscosity meter is preferably 10000 mPa·s or less, more preferably 5000 mPa·s or less, particularly preferably 2000 mPa·s or less. Even if this viscosity is over 10000 mPa·s, the workability is not impaired when a resin composition having viscosity adjusted in the above-described range by heating is used. The viscosity of this resin composition at 70° C. measured by a rotary B-type viscosity meter is preferably 5000 mPa·s or less, more preferably 2000 mPa·s or less.

The viscosity of the resin composition can be adjusted by controlling the kind and the content of a monomer. Specifically, when a monomer containing a chemical structure or a functional group having an intermolecular interaction such as a hydrogen bond is used in large amount, the viscosity of the resin composition increases. When a low molecular weight monomer exhibiting no intermolecular interaction is used in large amount, the viscosity of the resin composition lowers.

### [Molded Article: Fine Uneven Structure Body]

The active energy ray-curable resin composition as explained above can be polymerized and cured to give a molded article. Especially a fine uneven structure body having a fine uneven structure on the surface is extremely useful as the molded article. The fine uneven structure body includes, for example, those having a substrate and a cured material having a fine uneven structure on the surface.

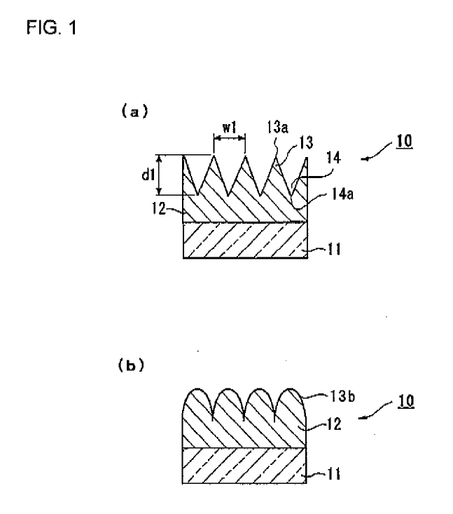

FIG. 1 is a schematic sectional view showing an embodiment of the fine uneven structure of the present invention. The fine uneven structure body shown in FIG. 1(a) has a layer (surface layer) 12 which is a cured material of the active energy ray-curable resin composition of the present invention laminated on a substrate 11. The surface of the layer 12 has a fine uneven structure. In the fine uneven structure, conical projecting parts 13 and recessed parts 14 are formed at equal intervals W1. The projecting part preferably has a shape such that the cross-sectional area in the perpendicular plane is continuously increased from the top side toward the substrate side since then refractive index can be increased continuously, a variation of reflectance depending on wavelength (wavelength dependency) can be suppressed, and scattering of visible light can be suppressed to attain low reflectance.

The interval w1 of projecting parts (or interval of recessed parts) is a distance equal to the wavelength of visible light (380 to 780 nm) or less. When the interval w1 of projecting parts is 380 nm or less, scattering of visible light can be suppressed and the structure can be suitably used as an antireflection film in optical applications.

The height of a projecting part or the depth of a recessed part, namely, the perpendicular distance d1 between the bottom point 14a of a recessed part and the top 13a of a projecting part is preferably a size by which a variation of reflectance depending on wavelength can be suppressed. Specifically, it is preferably 60 nm or more, more preferably 90 nm or more, particularly preferably 150 nm or more, most preferably 180 nm or more. When the perpendicular distance d1 is around 150 nm, reflectance at a wavelength of 550 nm which is recognizable most easily by a person can be made lowest. If the height of a projecting part is 150 nm or more, when the height of a projecting part is larger, a difference between the highest reflectance and the lowest reflectance in the visible light range is smaller. Because of this reason, when the height of a projecting part is 150 nm or more, wavelength dependency of reflected light is smaller, and a difference of color is not recognized visually.

Here, the interval and the height of projecting parts were measured in an image by a field emission-type scanning electron microscope (JSM-7400F: manufactured by JEOL Ltd.) at an accelerating voltage of 3.00 kV and the arithmetic averages of the measured values were employed.

The projecting part may have a campanulate shape in which the top 13b of the projecting part is curved as shown in FIG. 1(b), and additionally, a shape can be adopted such that the cross-sectional area in the perpendicular plane is continuously increased from the top side toward the substrate side.

The fine uneven structure is not limited to the embodiments shown in FIG. 1, and can be formed on one surface or the whole surface of a substrate or formed entirely or partially on a substrate. For effecting water-repellent performance, it is preferable that the tip of projection of a projecting part is narrower and it is preferable that the area occupied by a cured material in a contact surface between a fine uneven structure body and water drops is as small as possible.

Between the substrate 11 and the surface layer 12, an intermediate layer for improving various physical properties such as scratch resistance and adhesiveness may be provided.

The substrate may be any one as long as it can support a cured material having a fine uneven structure, and when a fine structure body is applied to a display member, a transparent substrate, that is, a molded body transmitting light is preferable. Examples of the material constituting the transparent substrate include synthetic polymers such as a methyl methacrylate (co)polymer, polycarbonate, a styrene (co)polymer and a methyl methacrylate-styrene copolymer; semi-synthetic polymers such as cellulose diacetate, cellulose triacetate and cellulose acetate butyrate; polyesters such as polyethylene terephthalate and polylactic acid; polyimide; polyimide; polyethersulfone; polysulfone; polyethylene; polypropylene; polymethylpentene; polyvinyl chloride; polyvinyl acetal; polyether ketone; polyurethane, a polymer composite thereof (e.g., a composite of polymethyl methacrylate and polylactic acid, a composite of polymethyl methacrylate and polyvinyl chloride); and glass.

The shape of the substrate may be any of a sheet shape and a film shape, and those produced by any method such as an injection molded product, an extrusion molded product and a cast molded product can be used. Furthermore, the surface of the substrate may be subjected to coating and corona processing in order to improve properties such as adhesion, antistatic property, scratch resistance and weather resistance.

Such a fine uneven structure body can be applied as an antireflection film, and provides high scratch resistance and pollutant removal effects such as excellent fingerprint removability.

### [Method for Producing Fine Uneven Structure Body]

Examples of the method for producing a fine uneven structure body include

(1) a method comprising: producing the above-described resin composition between a mold having an inversion structure of a fine uneven structure and a substrate, and curing the resin composition by irradiation of an activation energy ray, thereby transferring the uneven shape of the mold, and then detaching the mold, (2) a method comprising: transferring a uneven shape of a mold to a resin composition, detaching the mold, and then curing the resin composition by irradiation of an activation energy ray. Among them, the method (1) is particularly preferable in light of transferability of a fine uneven structure and the degree of freedom of the surface composition. This method is particularly suitable when a belt-type or roll-type mold capable of being continuously produced is used, and has excellent productivity.

The method of forming an inversion structure of a fine uneven structure on a mold is not particularly restricted, and specific examples thereof include an electron beam lithography method and a laser interference method. For example, a suitable photoresist film is applied on a suitable supporting substrate and developed by exposing to light such as ultraviolet laser, electron ray and X ray to obtain a die having a fine uneven structure formed thereon, and this die can be used as it is as a mold. It is also possible that a supporting substrate is selectively etched by dry etching via a photo-resist layer, and the resist layer is removed to form a fine uneven structure directly on the supporting substrate itself.

Further, it is also possible to utilize anodized porous alumina as a mold. For example, aluminum is anodized at a prescribed voltage using oxalic acid, sulfuric acid or phosphoric acid as an electrolyte to form a porous structure of 20 to 200 nm, and this structure may be utilized as a mold. According to this method, aluminum of high purity is anodized at constant voltage for a long period of time, then, the oxide coating is once removed, and anodized again, thus, extremely regular pores can be formed like self tissue. Further, it is also possible to form a fine uneven structure not having a rectangular cross-section but having a triangular or campanulate cross-section, by combining the anodizing treatment and pore diameter enlarging treatment in the second anodizing step. It is also possible to sharpen the angle at the inmost point of a pore, by appropriately adjusting the time and conditions of the anodizing treatment and pore diameter enlarging treatment.

Further, a replication form is manufactured from an original form having a fine uneven structure by an electro forming method, and this may be used as a mold.

The shape of a mold itself is not particularly restricted, and may be any of, for example, a flat plate shape, a belt shape and a roll shape. Particularly in the case of a belt shape and a roll shape, a fine uneven structure can be transferred continuously and productivity can be enhanced more.

The above-described resin composition is provided between such a mold and a substrate. The procedure for providing the resin composition between a mold and a substrate can be carried out by, for example, a method in which the resin composition is provided between a mold and a substrate and the mold and the substrate are pressed under this state to cause injection of the resin composition into a molding cavity.

The method for polymerizing and curing the resin composition between a substrate and a mold by irradiation of an activation energy ray is preferably a method for polymerizing and curing it by irradiation of ultraviolet ray. As the lamp for ultraviolet irradiation, for example, a high pressure mercury lamp, a metal halide lamp and a fusion lamp can be used.

The amount of irradiation of ultraviolet ray may be determined according to the absorption wavelength and content of a polymerization initiator. Usually, the integrated amount of light thereof is preferably 400 to 4000 mJ/cm², more preferably 400 to 2000 mJ/cm². When the integrated amount of light is 400 mJ/cm² or more, a resin composition can be sufficiently cured to suppress reduction in scratch resistance caused by insufficient curing. When the integrated amount of light is 4000 mJ/cm² or less, it is effective in view of preventing coloring of a cured material and deterioration of a substrate. Although the irradiation intensity is not also particularly limited, the irradiation intensity is preferably suppressed to output not to cause deterioration of a substrate and the like.

After polymerization and curing, a mold is detached, thereby obtaining a cured material having a fine uneven structure to give a fine uneven structure body.

When the above-described substrate is a molded body having a steric shape, the fine uneven structure body formed can be stuck on a molded body having a steric shape separately molded.

On thus obtainable fine uneven structure body, a fine uneven structure of a mold is transferred onto the surface in the relation between a key and a keyhole, thereby attaining high scratch resistance and water repellency, and excellent antireflection performance can be appeared by a continuous variation of refractive index, thus, this fine uneven structure body is suitable as an antireflection film of a film-shaped or steric-shaped molded article.

### [Water-Repellent Article]

The water-repellent article of the present invention may be an article having a fine uneven structure body having on its surface a fine uneven structure obtained by polymerizing and curing the resin composition of the present invention, or may be an article obtained by polymerizing and curing the resin composition of the present invention. The water-repellent article of the present invention has a water contact angle of preferably 130° or more, further preferably 140° or more. Further, a water drop falling down property is good on the water-repellent article. Particularly, the water-repellent article having a fine uneven structure body has high scratch resistance and good water repellency, and simultaneously, effects excellent antireflection performance. For example, the water-repellent article can be used in a state wherein the fine uneven structure body is stuck on the surface of a window material, a roofing tile, outdoor lighting, a convex mirror, a vehicle window, and a vehicle mirror.

When the fine uneven structure body of the present invention is used as an antireflection film, the antireflection film has not only antireflection performance but also high scratch resistance and good water-repellent performance. For example, the antireflection article can be used in a state where the fine uneven structure body is stuck on the surfaces of objects which includes image display devices such as a liquid crystal display device of a computer, a television set and a cellular phone; a plasma display panel, an electroluminescence display and a cathodic tube display device; a lens, a shop window, an eyeglass lens.

When a portion on which the fine uneven structure body of each of the above-mentioned object articles is to be stuck has a three-dimensional shape, the fine uneven structure body may be previously obtained by using a substrate having a shape corresponding to the three-dimensional shape, and forming a layer composed of a cured material of the resin composition of the present invention on the substrate, and then the fine uneven structure body is stuck on the predetermined portion of the object article. When the object article is an image display device, the fine uneven structure body may be stuck not only on the surface of the image display device but also on the front plate thereof, alternatively, the front plate itself can be formed of the fine uneven structure body.

The fine uneven structure body of the present invention can be also applied to optical applications such as an optical waveguide, a relief hologram, a lens and a polarization separating element, and applications such as a cell culture sheet, in addition to the above-mentioned applications.

### [Raw Material for Inprint]

The active energy ray-curable resin composition of the present invention can be used also as a raw material for inprint. The raw material for inprint is not particularly restricted as long as the raw material contains this resin composition. Though the resin composition can be used as it is, it is also possible that various additives are contained according to the intended molded article.

The inprint raw material can also be used for molding of a cured material by UV-curing or heat-curing using a mold. Use can be made also of a method of pressing a mold to a resin composition in a state semi-cured by heating, thereby transferring a shape, then, detaching the resin composition from the mold, and completely curing the resin composition by heat or UV.

The active energy ray-curable resin composition of the present invention can also be used as a raw material for forming a cured coating on various substrates, and can also be used as a coating material to form a coated film which is then irradiated with an active energy ray to form a cured material, in addition to the above-described applications.

### [Mold]

The mold of the present invention is a mold (molding die) having a fine uneven structure body having on its surface a fine uneven structure as a cured material of the resin composition of the present invention. Specifically, it may be a mold composed of a fine uneven structure body and other members (e.g., substrate), or may be a mold composed only of a fine uneven structure body. The mold of the present invention effects good releasability. The mold may have a film shape or a sheet shape. The film-shaped mold may also be wound on a roll and used.

A method of repeating transfer several times to manufacture replica molds from a precious mother mold, and transferring a fine uneven structure having the same shape as the mother mold is already known. For example, JP-A No. 2010-719 manufactures replica molds using anodized aluminum as a mother mold. Here, fluorine treatment is essential for use as a mold. It is because if the surface free energy of a mold resin is not lowered, good releasing is impossible.

In contrast, the mold of the present invention is capable of preventing permeation of a curable resin composition into mold, while providing releasability by the alkyl (meth)acrylate (A) that has an alkyl group of 12 or more carbon atoms, and effecting suitable hardness by the multifunctional monomer (B). As a result, the mold of the present invention is a mold excellent in releasability, without needing expensive post working such as fluorine treatment.

If the mold has a film shape, transferring to a rigid material such as glass also becomes easy. When the mold is transparent, it is also possible to form a fine uneven structure by light curing on an opaque substrate.

### [Method for Producing Fine Uneven Structure Body]

In the method for producing a fine uneven structure body, the mold of the present invention can be used. Examples of the method include (1) a method comprising: providing a thermoplastic resin on a substrate (e.g., applying a thermoplastic resin to form a layer), pressing a mold to the resin with heating, cooling, and then detaching the mold, (2) a method comprising: providing an active energy ray-curable resin composition between a mold and a substrate, curing the resin composition by irradiation of an active energy ray, and then detaching the mold, (3) a method comprising: transferring an uneven shape of a mold to an active energy ray-curable resin composition, detaching the mold, and then curing the resin composition by irradiation of an active energy ray. In these methods, an inversion structure of a fine uneven structure of a mold is formed on the surface of a thermoplastic resin layer or on the surface of a cured material of an active energy ray-curable resin composition.

The shape of the mold is not particularly restricted, and may be any of for example, a flat plate shape, a belt shape and a roll shape. Particularly in the case of a belt shape and a roll shape, a fine uneven structure can be transferred continuously and productivity can be enhanced more.

When a resin composition is provided between a mold and a substrate and then the mold and the substrate are pressed under this state, the resin composition is filled into a molding cavity (e.g., fine uneven structure of mold) by pressing force thereof.

The method for irradiating a resin composition between a substrate and a mold with an active energy ray to polymerize and cure the resin composition, polymerization and curing by irradiation with ultraviolet ray is preferable. As the lamp for ultraviolet irradiation, for example, a high pressure mercury lamp, a metal halide lamp and a fusion lamp can be used.

The amount of irradiation of ultraviolet ray may be determined according to the absorption wavelength and content of a polymerization initiator. Usually, the integrated amount of light thereof is preferably 400 to 4000 mJ/cm², more preferably 400 to 2000 mJ/cm². When the integrated amount of light is 400 mJ/cm² or more, a resin composition can be sufficiently cured to suppress reduction in scratch resistance caused by insufficient curing. When the integrated amount of light is 4000 mJ/cm² or less, it is effective in view of preventing coloring of a cured material and deterioration of a substrate. Although the irradiation intensity is not also particularly limited, the irradiation intensity is preferably suppressed to output not to cause deterioration of a substrate and the like.

After polymerization and curing, the mold is detached to obtain a cured material having a fine uneven structure, and a fine uneven structure body is obtained.

In the method for transferring an uneven shape of a mold to an active energy ray-curable resin composition, detaching the mold, and then curing the resin composition by irradiation of an active energy ray, the surface of a fine uneven structure body is not damaged easily because the mold is detached under a state of an un-cured resin composition.

Additionally, it is not occurred a defect caused by curing the resin composition under a state that air bubbles are present between the resin composition and the mold. Further, efficiency of curing of a fine uneven structure body is good, and the substrate film and the mold are not easily deteriorated because the resin composition can be irradiated with ultraviolet ray not via a substrate film.

As the resin composition used in the method for transferring an uneven shape of a mold to an active energy ray-curable resin composition, detaching the mold, and then curing the resin composition by irradiation of an active energy ray, those having ultrahigh viscosity and having a dynamic storage modulus at room temperature of 1×10⁷ Pa or more are preferable. When the dynamic storage modulus is 1×10⁷ Pa or more, pattern break and a stringy phenomenon are not caused during a period from detaching a mold until curing of a resin composition, and good shaping is attained.

When the substrate is a molded body having a steric shape, the fine uneven structure body formed can be stuck on a molded body having a steric shape separately molded.

On thus obtainable fine uneven structure body, a fine uneven structure of a mold is transferred onto the surface in the relation between a key and a keyhole, and excellent antireflection performance can be obtained by a continuous variation of refractive index, thus, this fine uneven structure body is suitable as an antireflection film of a film-shaped or steric-shaped molded article.

### EXAMPLES

Hereinafter, the present invention will be specifically described with reference to Examples. In the following description, the term “parts” means “parts by mass” unless otherwise specified. Various measurement and valuation methods are as follows.

### (1) Measurement of Micropores of Mold:

Platinum was vapor-deposited on a part of a vertical cross-section of a mold made of anodized porous alumina for 1 minute. The vertical cross-section was observed using a field emission-type scanning electron microscope (manufactured by JEOL Ltd., trade name: JSM-7400F) at an accelerating voltage of 3.00 kV, whereby intervals (periods) between the adjacent micropores and the depth of the micropores were measured. Specifically, each of the measurements was performed for 10 spots, and the average value thereof was determined as a measured value.

### (2) Measurement of Uneven of Fine Concave-Convex Structure Body:

Platinum was vapor-deposited on a vertical cross-section of a fine uneven structure body for 10 minutes. Intervals between the adjacent projecting parts or recessed parts and the height of the projecting parts were measured by the same apparatus as that of the item (1) in the same condition as that of the item (1). Specifically, each of the measurements was performed for 10 spots, and the average value thereof was determined as a measured value.

### (3) Evaluation of Condition of Resin Composition:

An active energy ray-curable resin composition was heated at 60° C., then, cooled, and the condition at 25° C. was observed.

### (4) Evaluation of Scratch Resistance:

A canvas cloth of 1 cm square was attached to an abrasion testing machine (manufactured by Shinto Scientific Co., Ltd., trade name: HEIDON). The surface of the fine uneven structure body was scratched 1000 times under conditions of a reciprocating distance of 50 mm and a head speed of 60 mm/s with a 100 g load applied to the canvas cloth. Then, the appearance was visually observed, and was evaluated according to the following standards.

“◯”: 0 to 2 flaws are confirmed.
“Δ”: 3 to 5 flaws are confirmed.
“x”: 6 or more flaws are confirmed.

### (5) Evaluation of Water Repellency (Measurement of Contact Angle):

1 μL of ion exchanged water was dropped on a fine uneven structure body, and the contact angle was calculated according to the θ/2 method using an automatic contact angle measuring apparatus (manufactured by KRUSS).

### (6) Evaluation of Water Repellency (Evaluation of Water Drop Falling Down Property):

20 μL and 50 μL of ion exchanged water were dropped on a fine uneven structure body, and water repellency was evaluated based on the degree of falling down of water drops at an inclination of 20°.

“◯”: Falling down.
“Δ”: Falling down when impacted.
“x”: No falling down. Water drops remain after falling down.

### [Fabrication of Mold]

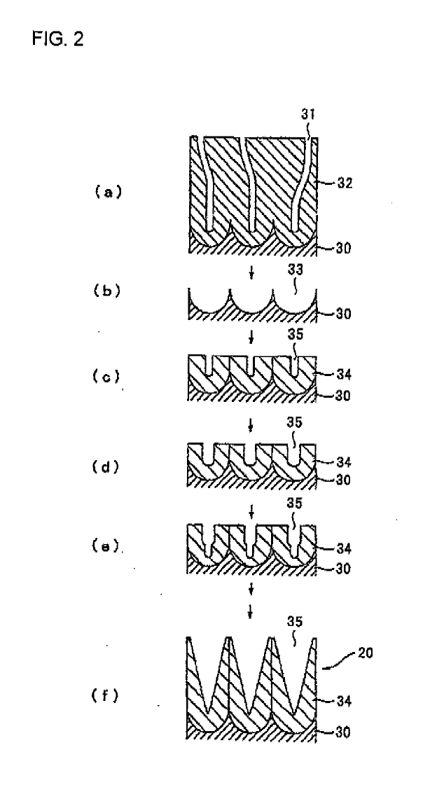

A mold (depth: 180 nm) was manufactured as described below according to the step shown in FIG. 2.

First, an aluminum plate 30 (purity of 99.99%) was subjected to fabric polishing and electrolytic polishing in a mixed solution of perchloric acid/ethanol (volume ratio: 1/4) to render the surface into a mirror surface.

### Step (a)

The aluminum plate 30 was anodized for 30 minutes in a 0.3 M aqueous oxalic acid solution under conditions of a direct current of 40 V and a temperature of 16° C., to generate a crack 31 on an oxide coating 32.

### Step (b)

The aluminum plate 30 was dipped in an aqueous mixed solution including 6% by mass of phosphoric acid/1.8% by mass of chromic acid for 6 hours, thereby removing the oxide coating 32, to expose periodic dents 33 corresponding to micropores 31.

### Step (c)

This aluminum plate was anodized for 30 seconds in a 0.3 M aqueous oxalic acid solution under conditions of a direct current of 40 V and a temperature of 16° C., to form an oxide coating 34. The oxide coating was formed along the aluminum surface, to provide micropores 35.

### Step (d)

The aluminum plate on which the oxide coating 34 had been formed was dipped in an aqueous phosphoric acid solution of 5% by mass at 32° C. for 8 minutes, thereby enlarging the diameter of the micropore 35.

### Step (e)

The above-mentioned steps (c) and (d) were repeated 5 times in total, thereby obtaining anodized porous alumina having micropores 35 of an approximately conical shape with a period of 100 nm and a depth of 180 nm. The resultant anodized porous alumina was washed in deionized water, and moisture on the surface thereof was then removed by air blow. The anodized porous alumina was dipped for 10 minutes in a solution obtained by diluting a surface antifouling coating agent (manufactured by Daikin Industries, Ltd., trade name: OPTOOL DSX) with a diluent (manufactured by HARVES Co., Ltd., trade name HD-ZV) so that the solid content of the surface antifouling coating agent was set to 0.1% by mass, and was air-dried for 20 hours, to obtain a mold 20.

### [Polymerization Reactive Monomer Component]

The physical properties of each of the monomers used in examples and comparative examples are shown in Table 1.

TABLE 1

| | | Sp value by | Number (N) of | Molecular | |
|---|---|---|---|---|---|
| | | Fedor's estimation | radically polymerizable | weight (W) | |
| | | method | functional group | [g/mol] | W/N |
| Monomer | TMPT-3EO | 19.92 | 3 | 428 | 143 |
| | PET-3 | 22.72 | 3 | 284 | 95 |
| | ATM-4E | 20.51 | 4 | 528 | 132 |
| | U-4HA | 23.44 | 4 | 568 | 142 |
| | DPHA-6EO | 20.62 | 6 | 842 | 140 |
| | MA | 18.3 | 1 | | |
| | C6DA | 19.56 | 2 | | |
| | X-22-1602 | 19.5~19.9 | 2 | | |

### Example 1

### Preparation of Resin Composition

10 parts of lauryl acrylate (manufactured by Shin-Nakamura Chemical Co., Ltd., trade name: BLEMMER LA) as the alkyl (meth)acrylate (A), 90 parts of ethoxylated pentaerythritol tetraacrylate (manufactured by Shin-Nakamura Chemical Co., Ltd., trade name: NK Ester ATM-4E) as the multifunctional monomer (B), 0.5 parts of 2,4,6-trimethylbenzoyl-diphenyl-phosphine oxide (manufactured by Nihon Ciba-Geigy K.K., trade name: DAROCURE TPO) as the active energy ray polymerization initiator and 0.1 part of an internal release agent (manufactured by Axel Plastics Research Laboratories, Inc., trade name: MoldWiz INT AM-121) were mixed to prepare an active energy ray-curable resin composition.

### [Manufacture of Fine Uneven Structure Body]

This active energy ray-curable resin composition was adjusted to 50° C., poured onto the surface having micropores of a mold adjusted to 50° C., and a polyethylene terephthalate film having a thickness of 38 μm (manufactured by Mitsubishi Plastics. Inc., trade name: WE97A) was coated thereon while spreading under press. Thereafter, the resin composition was irradiated with ultraviolet ray from the film side using a fusion lamp at a belt speed of 6.0 m/min so that the integrated amount of light was 1000 mJ/cm², to cure the resin composition. Then, the film and the mold were detached, to obtain a fine uneven structure body.

On the surface of the fine uneven structure body, the fine uneven structure of the mold was transferred, and a fine uneven structure an approximately conical shape with an interval w1 between the adjacent projecting parts 13 of 100 nm and a height d1 of the projecting parts 13 of 180 nm as shown in FIG. 1(a) was formed. This fine uneven structure body was evaluated, and the results are shown in Table 2.

### Examples 2 to 18

### Comparative Examples 1 to 11

Fine uneven structure bodies having the same size as in Example 1 were manufactured by the same manner as in Example 1 excepting that the monomer was changed to those shown in Tables 2 and 3, and evaluated. The results are shown in Tables 2 and 3. The unit of the blending amount in the tables is “part”.

TABLE 2

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Alkyl monomer (A) | LA | 10 | 5 | 10 | | | | | | |
| | CA | | | | 5 | 10 | 5 | 8 | 5 | |
| | SA | | | | | | | | | 5 |
| | VA | | | | | | | | | |
| Multifunctional monomer | PET-3 | | | 90 | | | | | 95 | |
| (B) | ATM-4E | 90 | 95 | | 95 | 90 | 90 | 85 | | 95 |
| | DPHA-6EO | | | | | | | | | |
| Multifunctional monomer | TMPT-3EO | | | | | | | | | |
| other than (B) | U-4HA | | | | | | | | | |
| Monomer (C) | MA | | | | | | | | | |
| | C6DA | | | | | | | | | |
| | X-22-1602 | | | | | | | | | |
| Release agent | INT AM-121 | 0.1 | 0.1 | 0.1 | 0.1 | 0.1 | 0.1 | 0.1 | 0.1 | 0.1 |
| Polymerization initiator | DAR TPO | 0.5 | 0.5 | 0.5 | 0.5 | 0.5 | 0.5 | 0.5 | 0.5 | 0.5 |
| Contact angle [°] | | 143.3 | 130.6 | 137.9 | 144.8 | 145.7 | 144.6 | 147.2 | 139.7 | 143.2 |
| Water drop falling down property (20 μL) | | X | X | X | ◯ | ◯ | ◯ | ◯ | Δ | ◯ |
| Water drop falling down property (50 μL) | | ◯ | Δ | ◯ | ◯ | ◯ | ◯ | ◯ | ◯ | ◯ |
| Condition of resin composition | | transpar- | transpar- | transpar- | transpar- | white | transpar- | transpar- | transpar- | separated |
| | | ent | ent | ent | ent | turbidity | ent | ent | ent | |
| Scratch resistance | | ◯ | ◯ | ◯ | ◯ | ◯ | ◯ | Δ | ◯ | ◯ |
| | | Ex. | Ex. | Ex. | Ex. | Ex. | Ex. | Ex. | Ex. | Ex. |
| | | 10 | 11 | 12 | 13 | 14 | 15 | 16 | 17 | 18 |
| Alkyl monomer (A) | LA | | | | | 7 | 8 | | | 10 |
| | CA | | | | | | | | 5 | |
| | SA | 10 | 5 | 5 | | | | 10 | | |
| | VA | | | | 5 | 3 | 2 | | | |
| Multifunctional monomer | PET-3 | | | 95 | | | | | | |
| (B) | ATM-4E | 90 | 90 | | 95 | 90 | 90 | 85 | | |
| | DPHA-6EO | | | | | | | | 90 | 90 |
| Multifunctional monomer | TMPT-3EO | | | | | | | | | |
| other than (B) | U-4HA | | | | | | | | | |
| Monomer (C) | MA | | 5 | | | | | | 5 | |
| | C6DA | | | | | | | | | |
| | X-22-1602 | | | | | | | 5 | | |
| Release agent | INT AM-121 | 0.1 | 0.1 | 0.1 | 0.1 | 0.1 | 0.1 | 0.1 | 0.1 | 0.1 |
| Polymerization initiator | DAR TPO | 0.5 | 0.5 | 0.5 | 0.5 | 0.5 | 0.5 | 0.5 | 0.5 | 0.5 |

| | | | | | | | | | |
|---|---|---|---|---|---|---|---|---|---|
| Contact angle [°] | 144.9 | 143.3 | 136.9 | 146.4 | 141.6 | 135.6 | 135.4 | 142 | 145.5 |
| Water drop falling down property (20 μL) | ◯ | ◯ | ◯ | ◯ | ◯ | Δ | X | ◯ | Δ |
| Water drop falling down property (50 μL) | ◯ | ◯ | ◯ | ◯ | ◯ | Δ | Δ | ◯ | ◯ |
| Condition of resin composition | separated | separated | separated | separated | separated | separated | separated | transpar- | transpar- |
| | | | | | | | | ent | ent |
| Scratch resistance | ◯ | ◯ | ◯ | ◯ | Δ | Δ | Δ | Δ | Δ |

TABLE 3

| | | Comp. | Comp. | Comp. | Comp. | Comp. | Comp. |
|---|---|---|---|---|---|---|---|
| | | Ex. 1 | Ex. 2 | Ex. 3 | Ex. 4 | Ex. 5 | Ex. 6 |
| Alkyl monomer (A) | LA | 10 | | | | | |
| | CA | | 2 | 20 | 5 | 10 | |
| | SA | | | | | | 2 |
| | VA | | | | | | |
| Multifunctional monomer (B) | PET-3 | | | | | | |
| | ATM-4E | | 98 | 80 | | | 98 |
| | DPHA-6EO | | | | | | |
| Multifunctional monomer | TMPT-3EO | 90 | | | 95 | 90 | |
| other than (B) | U-4HA | | | | | | |
| Monomer (C) | MA | | | | | | |
| | C6DA | | | | | | |
| | X-22-1602 | | | | | | |
| Rekease agent | INT AM-121 | 0.1 | 0.1 | 0.1 | 0.1 | 0.1 | 0.1 |
| Polymerization initiator | DAR TPO | 0.5 | 0.5 | 0.5 | 0.5 | 0.5 | 0.5 |

| | | | | | | |
|---|---|---|---|---|---|---|
| Contact angle [°] | 103.5 | 105.6 | 134.8 | 100.3 | 135.6 | 128.6 |
| Water drop falling down property (20 μL) | X | X | ◯ | X | X | X |
| Water drop falling down property (50 μL) | X | X | ◯ | X | X | X |
| Condition of resin composition | transparent | transparent | white | transparent | transparent | transparent |
| | | | | turbidity | | |
| Scratch resistance | ◯ | ◯ | X | ◯ | ◯ | ◯ |

| | | Comp. | Comp. | Comp. | | |
|---|---|---|---|---|---|---|
| | | Ex. 7 | Ex. 8 | Ex. 9 | Comp. Ex. 10 | Comp. Ex. 11 |
| Alkyl monomer (A) | LA | | | 10 | | |
| | CA | | | 5 | 10 | 2 |
| | SA | 5 | 5 | | | |
| | VA | | | | | |
| Multifunctional monomer (B) | PET-3 | | | | | |
| | ATM-4E | | | 80 | 80 | 88 |
| | DPHA-6EO | | | | | |
| Multifunctional monomer | TMPT-3EO | 95 | | | | |
| other than (B) | U-4HA | | 95 | | | |
| Monomer (C) | MA | | | 5 | | |
| | C6DA | | | | 10 | 10 |
| | X-22-1602 | | | | | |
| Rekease agent | INT AM-121 | 0.1 | 0.1 | 0.1 | 0.1 | 0.1 |
| Polymerization initiator | DAR TPO | 0.5 | 0.5 | 0.5 | 0.5 | 0.5 |

| | | | | | |
|---|---|---|---|---|---|
| Contact angle [°] | 120.4 | — | 142 | 142.9 | 129.4 |
| Water drop falling down property (20 μL) | X | — | X | X | X |
| Water drop falling down property (50 μL) | X | — | X | X | X |
| Condition of resin composition | transparent | separated | transparent | transparent | transparent |
| Scratch resistance | ◯ | ◯ | X | Δ | ◯ |

Abbreviations in Tables 1 to 3 are as described below,
“LA”: lauryl acrylate (manufactured by Shin-Nakamura Chemical Co., Ltd., trade name: BLEMMER LA, number of carbon atoms of alkyl group: 12)
“CA”: cetyl acrylate (manufactured by Shin-Nakamura Chemical Co., Ltd., trade name: BLEMMER CA, number of carbon atoms of alkyl group: 16)
“SA”: stearyl acrylate (manufactured by Shin-Nakamura Chemical Co., Ltd., trade name: BLEMMER SA, number of carbon atoms of alkyl group: 18)
“VA”: behenyl acrylate (manufactured by Shin-Nakamura Chemical Co., Ltd., trade name: BLEMMER VA, number of carbon atoms of alkyl group: 22)
“ATM-4E”: ethoxylated pentaerythritol tetraacrylate (manufactured by Shin-Nakamura Chemical Co., Ltd., trade name: NK Ester ATM-4E)
“DPHA-6EO”: ethoxylated dipentaerythritol hexa acrylate (manufactured by Dai-Ichi Kogyo Seiyaku Co., Ltd., trade name: NEW FRONTIER DPEA-6)
“PET-3”: pentaerythritol triacrylate (manufactured by Dai-Ichi Kogyo Seiyaku Co., Ltd., trade name: NEW FRONTIER PET-3)
“TMPT-3EO”: ethoxylated trimethylolpropane triacrylate (manufactured by Shin-Nakamura Chemical Co., Ltd., trade name: NK Ester TMPT-3EO)
“U-4HA”: tetrafunctional urethane acrylate (manufactured by Shin-Nakamura Chemical Co., Ltd., trade name: NK Oligo U-4HA)
“MA”: methyl acrylate (sp value: 18.3)
“C6DA”: 1,6-hexanediol diacrylate (manufactured by Osaka Organic Chemical Industry Ltd., trade name: VISCOAT 230) (sp value: 19.6)
“X-22-1602”: modified polydimethylsiloxane diacrylate (manufactured by Shin-Etsu Chemical Co Ltd., Silicone Diacrylate X-22-1602, sp value: 19.5 to 19.9)
“INT AM121”: internal release agent (manufactured by Axel Plastics Research Laboratories, Inc., trade name: MoldWiz INT AM-121)
“DAR TPO”: 2,4,6-trimethylbenzoyldiphenylphosphine oxide (manufactured by Nihon Ciba-Geigy K.K., trade name: DAROCURE TPO)

As is clear from the results shown in Table 2, the fine uneven structure of each example had good water repellency and scratch resistance.

In Comparative Examples 1, 4, 5 and 7, water repellency was not appeared due to excess compatibilization with the alkyl (meth)acrylate (A) because the multifunctional monomer (B) was not suitable. In Comparative Examples 2 and 6, good water repellency was not appeared because the amount of the alkyl (meth)acrylate (A) was too small. In Comparative Example 3, good water repellency was appeared, however, scratch resistance was poor because the amount of the alkyl (meth)acrylate (A) was too large and the amount of the multifunctional monomer (B) was too small. In Comparative Example 8, monomer components were not mixed even in heating because the multifunctional monomer (B) was not suitable. In Comparative Examples 9 and 10, water repellency was poor, the degree of cross-linking was low and scratch resistance was poor because the amounts of the alkyl (meth)acrylate (A) and the multifunctional monomer (B) were not suitable. Also in Comparative Example 11, scratch resistance was good since the degree of cross-linking was high, though water repellency was poor.

### Example 19

The fine uneven structure body obtained in Example 7 was used as a mold having a film shape, and a fine uneven structure body was manufactured as described below.

### [Preparation of Resin Composition]

50 parts of ethoxylated dipentaerythritol hexa acrylate (manufactured by Dai-Ichi Kogyo Seiyaku Co., Ltd., trade name: NEW FRONTIER DPEA-6), 50 parts of 1,6-hexanediol diacrylate and 0.5 parts of 2,4,6-trimethylbenzoyl-diphenyl-phosphine oxide (manufactured by Nihon Ciba-Geigy K.K., trade name: DAROCURE TPO) as the active energy ray polymerization initiator were mixed, to prepare an active energy ray-curable resin composition.

### [Manufacture of Fine Uneven Structure Body]

This active energy ray-curable resin composition was dropped on the fine uneven structure body obtained in Example 7, a polycarbonate plate having a thickness of 500 μm (manufactured by Teijin Chemicals Ltd., trade name: PC1151) was laid thereon, and a roller was pushed on the polycarbonate plate to spread the curable resin composition. Thereafter, the resin composition was irradiated with ultraviolet ray from the polycarbonate plate side using a fusion lamp at a belt speed of 6.0 m/min so that the integrated amount of light was 1000 mJ/cm², to cure the resin composition. Then, the mold was detached, to obtain the polycarbonate plate carrying a fine uneven structure body of the same shape as that of the anodized porous alumina.

### INDUSTRIAL APPLICABILITY

The fine uneven structure body obtained by curing the active energy ray-curable resin composition of the present invention provides high scratch resistance and good water repellency simultaneously while maintaining excellent optical performance as a fine uneven structure body, thus, can be utilized, for example, for building materials such as walls and roofs, window materials of houses, automobiles, trains and ships, and mirrors, which is industrially extremely useful. The fine uneven structure body is also utilizable in applications such as a display needing antireflection performance.

### DESCRIPTION OF MARKS

10 fine uneven structure body
11 substrate
12 surface layer (cured material)
13 projecting part
13a top of projecting part
13b top of projecting part
14 recessed part
14a bottom point of recessed part
20 mold
30 aluminum plate
31 crack
32 oxide coating
33 dent
34 oxide coating
35 micropore

1. An active energy ray-curable resin composition comprising
3 to 18 parts by mass of an alkyl (meth)acrylate (A) having an alkyl group of 12 or more carbon atoms, and
82 to 97 parts by mass of a multifunctional monomer (B) having 3 or more radical polymerizable functional groups in the molecule wherein the sp value as expressed by the Fedor's estimation method is 20 to 23,
per 100 parts by mass of the total content of all monomers.

2. The active energy ray-curable resin composition according to claim 1, which contains no solvent.

3. The active energy ray-curable resin composition according to claim 1, which further comprises 0 to 15 parts by mass of a monomer (C) having at least one radical polymerizable functional group per 100 parts by mass of the total content of all monomers.

4. The active energy ray-curable resin composition according to claim 1 which further comprises a slip agent (D).

5. A molded article composed of a cured material of the active energy ray-curable resin composition according to claim 1.

6. A fine uneven structure body which is a cured material of the active energy ray-curable resin composition according to claim 1, and has a fine uneven structure on the surface.

7. A water-repellent article having the fine uneven structure body according to claim 6.

8. A method for producing a fine uneven structure body comprising a substrate and a cured material having a fine uneven structure on the surface, comprising
providing the active energy ray-curable resin composition according to claim 1 between the substrate and a mold having an inversion structure of the fine uneven structure,
curing the activation energy ray-curable resin composition by irradiation of an activation energy ray, and
detaching the mold to form a cured material having the fine uneven structure on the surface.

9. A mold having the fine uneven structure body according to claim 6.

10. A method for producing a fine uneven structure body comprising a substrate and a thermoplastic resin layer having a fine uneven structure on the surface, comprising
providing a thermoplastic resin on the substrate,
pressing the mold according to claim 9 onto the thermoplastic resin with heating, and then cooling it, and
detaching the mold to form a cured material having a structure on the surface of the thermoplastic resin layer which corresponds to an inversion structure of the fine concave-convex structure of the mold.

11. A method for producing a fine uneven structure body comprising a substrate and a cured material having a fine uneven structure on the surface, comprising
providing an active energy ray-curable resin composition between the mold according to claim 9 and the substrate,
curing the activation energy ray-curable resin composition by irradiation of an activation energy ray, and
detaching the mold to form a cured material having a structure on the surface which corresponds to an inversion structure of the fine uneven structure of the mold.

12. A method for producing a fine uneven structure body comprising a substrate and a cured material having a fine uneven structure on the surface, comprising
transferring the fine uneven structure of the mold according to claim 9 to the active energy ray-curable resin composition, and then detaching the mold, and
curing the active energy ray-curable resin composition to form a cured material having a structure on the surface which corresponds to an inversion structure of the fine uneven structure of the mold.
